(19) United States
(12) Patent Application Publication
(10) Pub. No.: US 2009/0181299 A1
(43) Pub. Date: Jul. 16, 2009

(54) AA ALKALINE BATTERY

(76) Inventors: Fumio KATO, Osaka (JP); Yasushi Sumihiro, Hyogo (JP); Seiji Wada, Osaka (JP)

Correspondence Address: MCDERMOTT WILL & EMERY LLP, 600 13TH STREET, NW, WASHINGTON, DC, 20005-3096, US

(21) Appl. No.: 12/334,939

(22) Filed: Dec. 15, 2008

Related U.S. Application Data
(60) Provisional application No. 61/022,670, filed on Jan. 22, 2008.

(30) Foreign Application Priority Data
Jan. 11, 2008 (JP) JP 2008-004682

(51) Int. Cl. H01M 2/08

(52) U.S. Cl. 429/185

(57) ABSTRACT

In an AA alkaline battery according to the present invention, the opening of a battery case is sealed with a gasket. In the battery case, a positive electrode, a negative electrode, a separator, and an alkaline electrolyte are provided. The negative electrode contains 4.0 g or more of zinc. The gasket has a hydrogen gas permeability coefficient, per one gasket, in the range from 1.2×110⁻¹⁰ (cm³H₂(STP)/sec·cmHg) to 9.9×10⁻¹⁰ (cm³H₂(STP)/sec·cmHg), both inclusive.

### BACKGROUND OF THE INVENTION

(1) Field of the Invention

The present invention relates to AA alkaline batteries.

(2) Disclosure of Related Art

In alkaline batteries, there is the possibility of generation of hydrogen gas for the structural reasons. The generation of hydrogen gas increases the internal pressure, thus causing a hazard. In view of this, alkaline batteries are designed to prevent generation of hydrogen gas or to ensure the safety of the batteries even with generation of hydrogen gas.

Specifically, an alkaline battery uses zinc as a negative electrode active material and also uses a strong alkaline electrolyte as an electrolyte which is in contact with a negative electrode. Accordingly, the surface of zinc might be corroded by the strong alkaline electrolyte so that hydrogen gas is generated. Since the alkaline battery is hermetically sealed, generation of hydrogen gas in the alkaline battery increases the pressure inside the alkaline battery to cause a hazard to the alkaline battery. To prevent this, bismuth or indium, for example, is added to the negative electrode in the alkaline battery in order to suppress corrosion of zinc by the alkaline electrolyte. In case of an increase in internal pressure of the alkaline battery, the thinner portion of a gasket is broken to reduce the pressure inside the alkaline battery. However, when a thinner portion of the gasket is broken, not only hydrogen gas but also an alkaline electrolyte leaks.

In view of this, as a technique for suppressing leakage of an alkaline electrolyte, Japanese Laid-Open Patent Publication No. 60-77352 (hereinafter, referred to as Patent Document 1) disclosed that the use of nylon 6-12 for a gasket provides the gasket with a high mechanical strength so that leakage of an alkaline electrolyte is suppressed.

Japanese Laid-Open Patent Publication No. 11-250875 (hereinafter, referred to as Patent Document 2) disclosed that the use of a material having high hydrogen permeability for a gasket suppresses an increase in internal pressure of an alkaline battery so that breakage of a thinner portion of a gasket is suppressed and, as a result, leakage of an alkaline electrolyte is suppressed.

### SUMMARY OF THE INVENTION

However, the technique disclosed in Patent Document 1 only increases the mechanical strength of a gasket. Specifically, the technique only prevents the gasket from being broken in attaching a sealing plate to the opening of a battery case.

In recent years, increase in capacity and power and cost reduction have been required of AA alkaline batteries. However, Patent Documents 1 and 2 do not mention enhancement of the leakage resistance in such alkaline batteries exhibiting high capacity and high power and fabricated at low cost. In addition, it was found that even the use of a material having high hydrogen permeability for a gasket as in Patent Document 2 insufficiently increases the leakage resistance of an alkaline battery exhibiting high capacity and high power and fabricated at low cost.

It is therefore an object of the present invention to enhance the leakage resistance, while achieving increase in capacity and power and cost reduction.

In an AA alkaline battery according to the present invention, a battery case is tightly sealed with a gasket. In the battery case, a positive electrode, a negative electrode, a separator, and an alkaline electrolyte are provided. The negative electrode contains 4.0 g or more of zinc. The gasket has a hydrogen gas permeability coefficient, per one gasket, in the range from 1.2×10⁻¹⁰ (cm³H₂(STP)/sec·cmHg) to 9.9×10⁻¹⁰ (cm³H₂(STP)/sec·cmHg), both inclusive.

In the above configuration, the content of zinc is higher than that in a conventional AA alkaline battery. As a result, the capacity is increased, as compared to the conventional AA alkaline battery.

In addition, when hydrogen gas is generated in the AA alkaline battery, the hydrogen gas is released to outside the AA alkaline battery without breakage of the gasket. Accordingly, even when hydrogen gas is generated in the AA alkaline battery, leakage of the alkaline electrolyte is suppressed.

In a preferred embodiment below, the gasket has a thinner portion having a thickness, along the length of the battery case, smaller than the other portion of the gasket. In this case, the thickness of the thinner portion is 0.25 mm or less, and the thinner portion has a cross-sectional area of 0.04 cm² or more in the direction vertical to the thickness direction of the thinner portion.

Specifically, the gasket is preferably made of one of nylon 6-12 and a plastic containing nylon 6-12 as a main agent.

In the inventive AA alkaline battery, the negative electrode preferably contains 400 ppm or less of indium with respect to the weight of zinc contained in the negative electrode.

### BRIEF DESCRIPTION OF THE DRAWINGS

FIG. 1 is a half sectional view illustrating a structure of an AA alkaline battery according to an embodiment of the present invention.

FIG. 2 is an enlarged view showing a region II in FIG. 1.

FIG. 3 is an enlarged view showing a region III in FIG. 2.

### DETAILED DESCRIPTION OF THE INVENTION

Prior to description of an embodiment of the present invention, examinations conducted by the inventors of the present invention are explained.

The inventors predict that increase in capacity and power and cost reduction recently required of AA alkaline batteries involve drawbacks as follows:

Specifically, it is predicted that when the loading weight of the negative electrode active material is increased in order to increase the capacity of an AA alkaline battery, a larger amount of zinc is corroded by the alkaline electrolyte so that a larger amount of hydrogen gas is generated. It is also predicted that the increase in loading weight of the negative electrode active material reduces clearance in the battery case so that the internal pressure of the AA alkaline battery increases at higher speed. In addition, it is also predicted that when the amount of indium and bismuth is reduced in order to achieve power increase or cost reduction of the AA alkaline battery, it becomes more difficult to suppress corrosion of the negative electrode by the alkaline electrolyte, i.e., a larger amount of hydrogen gas is generated. In this manner, when the capacity and power of an AA alkaline battery are increased and the cost thereof is reduced, the amount of hydrogen gas generation increases.

An AA alkaline battery is designed such that a gasket is broken upon an increase of the internal pressure. Accordingly, when a larger amount of hydrogen gas is generated, the leakage resistance decreases. In other words, it is conceivable that if hydrogen gas is released without breakage of a gasket even upon an increase in the internal pressure of an AA alkaline battery, decrease of the leakage resistance is suppressed even with an increase in the amount of hydrogen gas generation. In view of this, on the assumption that the use of a material having a high hydrogen permeability for a gasket as in Patent Document 2 would allow only hydrogen gas to be released even upon an increase in the internal pressure of an AA alkaline battery, the inventors examined the leakage resistance by using such a gasket. However, it was found that this structure was not enough to increase the leakage resistance. From this result, the inventors concluded as follows:

According to fluid mechanics, the amount of hydrogen gas passing through a gasket is expressed by Equation 1:

(the amount of hydrogen gas permeation)=k×(Pf−Pi)×(S/d) (1)

where k is a coefficient and depends on the material of the gasket, Pi is the internal pressure of a battery, Pf is a pressure outside the battery, and d is the thickness of a portion of the gasket through which hydrogen gas passes. Most part of hydrogen gas is considered to pass through a thinner portion provided in the gasket. Therefore, d is the thickness of the thinner portion of the gasket. In Equation 1, S is the cross-sectional area of the thinner portion of the gasket along the direction vertical to the thickness of the gasket.

Equation 1 shows that the amount of hydrogen gas permeation is proportional to the coefficient k, is proportional to the cross-sectional area S of the thinner portion of the gasket, and is inversely proportional to the thickness d of the thinner portion of the gasket. Patent Document 2 only specifies the hydrogen permeability of the material for a gasket, i.e., only specifies the coefficient k in Equation 1. Accordingly, even if the gasket is made of a material having a large coefficient k, the amount of hydrogen gas permeation is small as long as the cross-sectional area S of the thinner portion of the gasket is small or the thinner portion of the gasket has a large thickness. In contrast, even if the coefficient k is not so large, the amount of hydrogen gas permeation is increased as long as the cross-sectional area S of the thinner portion of the gasket is increased or the thickness of the thinner portion of the gasket is reduced.

From the foregoing facts, the inventors found that a sufficient amount of hydrogen gas permeation is assured by optimizing not only the material of the gasket but also the shape of the gasket to complete the present invention. Hereinafter, an embodiment of the present invention will be described with reference to the drawings. It should be noted that the present invention is not limited to the following embodiment.

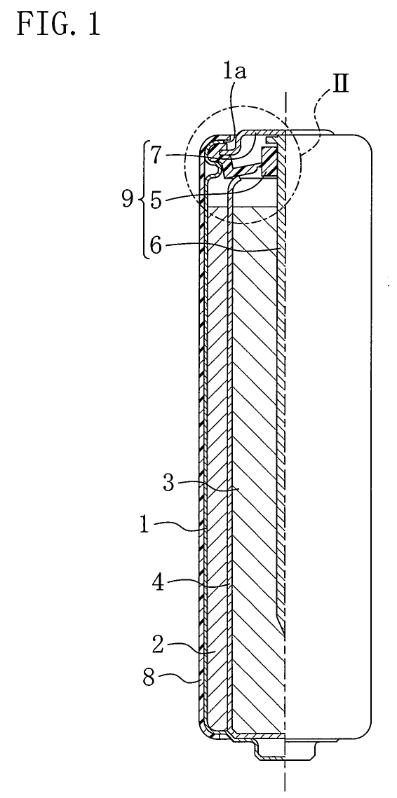

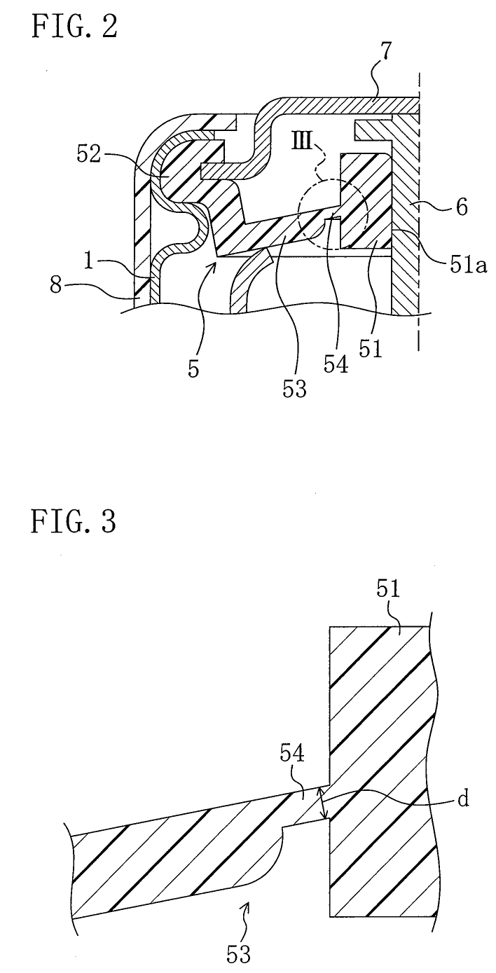

FIG. 1 is a cross-sectional view illustrating a structure of a general alkaline battery as an embodiment of the present invention. FIG. 2 is an enlarged view showing a region II in FIG. 1. FIG. 3 is an enlarged view showing a region III in FIG. 2.

As illustrated in FIG. 1, the AA alkaline battery includes a cylindrical battery case 1 which is sealed at one end (i.e., at the lower end in FIG. 1). The outer surface of the battery case 1 is covered with an exterior label 8. The battery case 1 serves as a positive electrode terminal and a positive electrode current collector. A hollow cylindrical positive electrode 2 is inscribed in the battery case 1. A separator 4 is provided in the hollow portion of the positive electrode 2 and formed in the shape of a cylinder which is sealed at one end. A negative electrode 3 is placed in the hollow portion of the separator 4. Accordingly, the battery case 1 is configured such that the positive electrode 2, the separator 4, and the negative electrode 3 are arranged in this order in the direction from the periphery to the center thereof.

An opening la of the battery case 1 is sealed by an assembled sealing unit 9. The assembled sealing unit 9 is configured by integrating a nail-shaped negative electrode current collector 6, a negative electrode terminal plate 7, and a gasket 5. The negative electrode terminal plate 7 is electrically connected to the negative electrode current collector 6. The gasket 5 is fixed to the negative electrode current collector 6 and the negative electrode terminal plate 7. In fabricating an alkaline battery, power generation elements such as the positive electrode 2 and the negative electrode 3 are housed in the battery case 1, and then the opening 1a of the battery case 1 is sealed by the assembled sealing unit 9.

The positive electrode 2, the negative electrode 3, and the separator 4 contain an alkaline electrolyte (not shown). As the alkaline electrolyte, an aqueous solution containing 30 to 40 wt. % of potassium hydroxide and 1 to 3 wt. % of zinc oxide is used.

Now, compositions, for example, of the positive electrode 2, the negative electrode 3, the separator 4, the battery case 1, the negative electrode current collector 6, and the negative electrode terminal plate 7 are described.

The positive electrode 2 contains a mixture of a positive electrode active material such as electrolytic manganese dioxide powder, a conductive agent such as graphite powder, and an alkaline electrolyte. A binder such as polyethylene powder or a lubricant such as stearate may be added to the positive electrode 2 as necessary.

The negative electrode 3 is obtained by, for example, adding a gelling agent such as sodium polyacrylate to an alkaline electrolyte and dispersing zinc alloy powder (i.e., a negative electrode active material) in the resultant gelled alkaline electrolyte. To enhance corrosion resistance of the negative electrode 3 against an alkaline electrolyte, a metal compound, such as bismuth, having a high hydrogen overvoltage may be added to the negative electrode 3 as necessary. To suppress zinc dendrite formation, a trace amount of a silicon compound such as silicic acid or silicate may be added to the negative electrode 3 as necessary. The negative electrode 3 is specifically described below.

As the separator 4, nonwoven fabric obtained by mixing mainly polyvinyl alcohol fiber and rayon fiber is used, for example. The separator 4 is obtained with a known method disclosed in, for example, Japanese Laid-Open Patent Publications Nos. 6-163024 and 2006-32320.

The battery case 1 is obtained by, for example, press-molding a nickel-coated steel plate into a predetermined shape having predetermined dimensions with a known method disclosed in, for example, Japanese Laid-Open Patent Publications Nos. 60-180058 and 11-144690.

The gasket 5 includes a center portion 51, a peripheral portion 52, and a connecting portion 53. The center portion 51 is a cylindrical member provided at the center of the opening 1a of the battery case 1 and has a through hole 51a extending along the length of the battery case 1. The negative electrode current collector 6 is inserted into the through hole 51a. The peripheral portion 52 is a cylindrical member provided at the periphery of the opening 1a of the battery case 1 (specifically, provided between the negative electrode terminal plate 7 and the inner wall of the battery case 1). The connecting portion 53 connects the center portion 51 and the peripheral portion 52 and has a thinner portion 54. The thinner portion 54 is thinner than the other portion of the connecting portion 53, the center portion 51, and the peripheral portion 52. The gasket 5 is described in more detail below.

The negative electrode current collector 6 is obtained by press-molding a wire material of, for example, silver, copper, or brass into a nail shape having predetermined dimensions. To eliminate mixture of an impurity during the molding and conceal an impurity, the surface of the negative electrode current collector 6 is preferably plated with, for example, tin or indium.

The negative electrode terminal plate 7 includes a terminal portion (not shown) for sealing the opening 1a of the battery case 1 and a circumferential flange portion which extends from the terminal portion (not shown) and is in contact with the gasket 5. The circumferential flange portion has a plurality of gas holes (not shown) for releasing pressure when the safety valve of the gasket 5 is actuated. The negative electrode terminal plate 7 is obtained by, for example, press-molding a nickel-coated or tin-coated steel plate into a predetermined shape having predetermined dimensions.

Now, the negative electrode 3 and the gasket 5 of this embodiment are described.

The negative electrode 3 of this embodiment contains zinc as an active material, as in a negative electrode of a conventional AA alkaline battery, but the amount of zinc contained in the negative electrode 3 of this embodiment is larger than that in the conventional AA alkaline battery. Specifically, the AA alkaline battery of this embodiment contains 4.0 g or more of zinc, whereas the conventional AA alkaline battery contains about 3.8 g of zinc. In this manner, the AA alkaline battery of this embodiment contains a larger amount of zinc than the conventional AA alkaline battery. As a result, the capacity is increased.

The negative electrode 3 of this embodiment contains indium, as in the negative electrode of the conventional AA alkaline battery, but the amount of indium is smaller than that in the conventional AA alkaline battery. Specifically, the ratio of the weight of indium with respect to the weight of zinc is 400 ppm or less in the negative electrode 3 of the AA alkaline battery of this embodiment, while being generally about 500 ppm in the conventional AA alkaline battery. In this manner, the AA alkaline battery of this embodiment contains a smaller amount of indium than the conventional AA alkaline battery so that the content of the active material is increased and, thus, the reaction efficiency of zinc serving as the negative electrode active material is enhanced. As a result, the power of the AA alkaline battery is increased. In addition, in the AA alkaline battery of this embodiment, the weight of expensive indium is reduced as compared to the conventional AA alkaline battery. As a result, the cost is reduced.

To achieve higher power and lower cost of the AA alkaline battery, the ratio of the weight of indium with respect to the weight of zinc is preferably reduced. However, if the ratio is excessively low, generation of hydrogen gas is hardly suppressed, loosing significance in providing indium. Accordingly, the ratio of the weight of indium with respect to the weight of zinc only needs to be 400 ppm or less, and preferably in the range from 100 ppm to 400 ppm, both inclusive.

As described above, in such an AA alkaline battery exhibiting high capacity and high power and fabricated at low cost, the leakage resistance decreases, as compared to a conventional AA alkaline battery. However, since the gasket 5 is designed as described below in this embodiment, only hydrogen gas is released without breakage of the thinner portion 54 of the gasket 5 upon generation of hydrogen gas in an AA alkaline battery.

The gasket 5 of this embodiment is designed to pass hydrogen gas therethrough. Specifically, the gasket 5 is designed such that the hydrogen gas permeability coefficient per one gasket is in the range from 1.2×10⁻¹⁰ (cm³H₂(STP)/sec·cmHg) to 9.9×10⁻¹⁰ (cm³H₂(STP)/sec·cmHg), both inclusive. The hydrogen gas permeability coefficient per one gasket depends on both the material and shape of the gasket 5 and is k×(S/d) in Equation 1. A sufficient amount of hydrogen gas permeation is assured as long as the hydrogen gas permeability coefficient per one gasket 5 is within the above range. Accordingly, when hydrogen gas is generated in an AA alkaline battery, this hydrogen gas is released from the AA alkaline battery without breakage of the gasket 5. As a result, the leakage resistance is increased.

It is unpreferable that the hydrogen gas permeability coefficient per one gasket 5 is less than 1.2×10⁻¹⁰ (cm³H₂(STP)/sec·cmHg) because it is difficult to assure a sufficient amount of hydrogen gas permeated through the gasket 5. The hydrogen gas permeability coefficient per one gasket 5 is preferably as large as possible in order to assure a sufficient amount of hydrogen gas permeated through the gasket 5. However, hydrogen gas permeability coefficients per one gasket 5 exceeding 9.9×10⁻¹⁰ (cm³H₂(STP)/sec·cmHg) are unpreferable because hydrogen gas released from an AA alkaline battery might fill airtight apparatus in which the AA alkaline battery is incorporated.

Now, the gasket 5 is described in further detail. Since the hydrogen gas permeability coefficient per one gasket 5 depends on the material and shape of the gasket 5 as described above, the hydrogen gas permeability coefficient per one gasket 5 is adjusted within the above-mentioned range by optimizing the material and shape of the gasket 5. First, the material of the gasket 5 (i.e., the coefficient k in Equation 1) is explained.

The gasket 5 is preferably made of a material exhibiting high permeability with respect to hydrogen gas (i.e., a material having a large coefficient k in Equation 1) or preferably uses, as a main agent, a material exhibiting high permeability with respect to hydrogen gas. Specifically, the gasket 5 is preferably made of nylon 6-12 or contains nylon 6-12 as a main agent.

In this case, the phrase “the gasket 5 contains nylon 6-12 as a main agent” means that the content of nylon 6-12 is enough to assure a sufficient amount of hydrogen gas permeation.

Next, the shape of the gasket 5 (i.e., the cross-sectional area S and the thickness d in Equation 1) is explained.

To assure a sufficient amount of hydrogen gas permeation, the gasket 5 is preferably designed to have a large cross-sectional area (S) and a small thickness (d) of the thinner portion 54 as shown in Equation 1. Specifically, the cross-sectional area (S) of the thinner portion 54 is 0.04 cm² or more. The thickness (d) of the thinner portion 54 is 0.25 mm or less. The cross-sectional area (S) of the thinner portion 54 is a cross-sectional area taken vertically to the thickness thereof, but may be the area of the bottom of the thinner portion 54 illustrated in FIG. 3.

When the cross-sectional area (S) of the thinner portion 54 is excessively large, the explosion prevention actuating pressure might be unstable. In other words, an excessively large cross-sectional area (S) of the thinner portion 54 is unpreferable because the thinner portion 54 might be broken upon an increase in internal pressure of the AA alkaline battery. Consequently, leakage of the alkaline electrolyte is not suppressed.

In addition to the thinner portion 54, the center portion 51, the peripheral portion 52, and the connecting portion 53 are provided in the gasket 5 whose size depends on the size of the AA alkaline battery that is defined according to the standard. Accordingly, when the cross-sectional area (S) of the thinner portion 54 is excessively large, the thinner portion 54 occupies a larger part of the gasket 5, resulting in failures in functions of the center portion 51 and the peripheral portion 52 in some cases. For example, when the center portion 51 occupies a smaller part of the gasket 5, it becomes difficult to firmly hold the negative electrode current collector 6 in the through hole 51a of the center portion 51. When the peripheral portion 52 occupies a smaller part of the gasket 5, the gasket 5 cannot be fixed to the battery case 1, thus making it difficult to tightly seal the AA alkaline battery. From the foregoing consideration, the cross-sectional area (S) of the thinner portion 54 is 0.04 cm² or more, and is preferably in the range from 0.04 cm² to 0.2 cm², both inclusive.

An excessively small thickness (d) of the thinner portion 54 is unpreferable because the thinner portion 54 might be broken in forming the gasket 5 so that the yield of the gasket 5 decreases. In addition, when the thickness (d) of the thinner portion 54 is excessively small, it is difficult to stabilize the explosion prevention actuating pressure. In other words, the thinner portion might be broken upon an increase in internal pressure of the AA alkaline battery as in a conventional AA alkaline battery so that leakage of the alkaline electrolyte cannot be suppressed. From the foregoing consideration, the thickness (d) of the thinner portion 54 is 0.25 mm or less, and preferably in the range from 0.12 mm to 0.25 mm, both inclusive.

As described above, the AA alkaline battery of this embodiment exhibits higher power and higher capacity and is fabricated at lower cost than a conventional AA alkaline battery, and is capable of suppressing leakage therefrom.

Though not specifically described in this embodiment, since the amount of the negative electrode active material is larger than that in the conventional AA alkaline battery, the amount of the positive electrode active material is preferably increased accordingly.

The gasket 5 is not limited to the shape illustrated in FIG. 2 as long as the cross-sectional area of the thinner portion 54 is 0.04 cm² or more (preferably in the range from 0.04 cm² to 0.2 cm², both inclusive) and the thickness of the thinner portion 54 is 0.25 mm or less (preferably in the range from 0.12 mm to 0.25 mm, both inclusive).

### EXAMPLE

An example of the present invention is now described. In Example, as a preliminary examination, the hydrogen gas permeability coefficient (i.e., the coefficient k in Equation 1) of nylon resin (which is a material of a gasket) was measured by using a sheet of this nylon resin. In addition, an AA alkaline battery was fabricated according a method described below, and then the AA alkaline battery was overdischarged to check the safety thereof.

### (Preliminary Examination)

The hydrogen gas permeability coefficient (i.e., the coefficient k in Equation 1) of nylon resin as a material of a gasket was measured using a sheet of this nylon resin (having a thickness of about 0.7 mm) by a differential pressure method conforming to JIS K7176-1. The hydrogen gas permeability coefficient (i.e., the coefficient k in Equation 1) of the nylon resin was measured under conditions shown in Table 1.

TABLE 1

| | |
|---|---|
| Measurement | differential pressure gas/vapor permeability |
| equipment | measurement equipment GTR-30X produced |
| | by GTR Tech Corporation |
| Detector | gas chromatograph (thermal conductivity detector) |
| Permeation area | 1.52 × 10⁻³ m² (diameter φ: 4.4 × 10⁻² m) |
| Permeated gas | hydrogen gas in a humidified atmosphere of 90% RH |
| Temperature | 25 ± 2° C. |
| Differential | 1 atm |
| pressure | (hydrogen partial pressure: 73.86 cmHg |
| | water vapor partial pressure: 2.14 cmHg) |

As a gasket, a gasket of nylon 6-12 was used in Example, whereas a gasket of nylon 6-6 was used in Comparative Example, as described below. Nylon 6-12 and nylon 6-6 were selected as nylon resin so that the hydrogen gas permeability coefficient (i.e., the coefficient k in Equation 1) was measured for each example. Then, the hydrogen gas permeability coefficient (i.e., the coefficient k in Equation 1) of nylon 6-12 was 1.06×10⁻¹⁰ (cm³H₂(STP)·cm/cm²·sec·cmHg) and the hydrogen gas permeability coefficient (i.e., the coefficient k in Equation 1) of nylon 6-6 was 3.39×10⁻¹¹ (cm³H_{2 (STP)-cm/cm}²·sec·cmHg).

### (Method for Fabricating AA Alkaline Battery According to Example)

First, zinc alloy particles containing 0.005 wt. % of Al, 0.005 wt. % of Bi, and 0.020 wt. % of In with respect to the weight of zinc were prepared by a gas atomizing method. Then, these zinc alloy particles were classified with a screen. With this classification, a negative electrode active material which had a grain size of 70 to 300 meshes and in which the ratio of zinc alloy particles having a grain diameter of 200 meshes (i.e., 75 μm) or less was 30% was obtained.

Next, polyacrylic acid and sodium polyacrylate were added to and mixed with 100 weight parts of 34.5 wt. % of a potassium hydroxide aqueous solution (containing 2 wt. % of ZnO) in such a manner that the total weight was 2.2 weight parts, and the resultant mixture was made into gel, thereby obtaining a gelled electrolyte. Thereafter, this gelled electrolyte was left alone for 24 hours to be sufficiently matured.

Then, the zinc alloy particles in an amount 2.00 times as much as a given amount of the gelled electrolyte in weight ratio was added to and sufficiently mixed with the gelled electrolyte, thereby obtaining a gelled negative electrode.

Thereafter, electrolytic manganese dioxide (HHTF: a product by TOSOH CORPORATION) and graphite (SP-20: a product by Nippon Graphite Industries, ltd.) were blended at a weight ratio of 94:6, thereby obtaining mixed powder. With 100 weight parts of this mixed powder, 1.5 weight parts of an electrolyte (e.g., 39 wt. % of a potassium hydroxide aqueous solution containing 2 wt. % of ZnO) and 0.2 weight part of a polyethylene binder were mixed. Then, the mixture was uniformly stirred and mixed by a mixer, and was sized to have a given grain size. The obtained grain substance was press formed into a hollowed cylindrical shape. In this manner, a positive electrode mixture in the form of a pellet was obtained.

Subsequently, a sample AA alkaline battery was prepared. Specifically, as illustrated in FIG. 1, two pellets of a positive electrode mixture (weight: 5.15 g per one pellet) were inserted into the battery case 1, and pressure was applied again thereto in the battery case 1, thereby bringing the pellets into close contact with the inner face of the battery case 1. Then, a separator 4 and a bottom insulator for insulating the bottom of the battery case 1 were placed inside the positive electrode mixture pellets. Thereafter, 1.5 g of an electrolyte (e.g., 34.5 wt. % of a potassium hydroxide aqueous solution containing 2 wt. % of ZnO) was injected. After the injection, the inside of the separator 4 was filled with 6.2 g of a gelled negative electrode 3 (containing 4.1 g of zinc alloy particles). Subsequently, the opening 1a of the battery case 1 was sealed by an assembled sealing unit 9 formed by integrating a resin gasket 5, a negative electrode current collector 6, and a negative electrode terminal plate 7. Specifically, the negative electrode current collector 6 was inserted in the negative electrode 3, and the circumferential flange portion of the negative electrode terminal plate 7 was crimped to the rim of the opening 1a of the battery case 1 with the peripheral portion 52 of the resin gasket 5 interposed therebetween, thereby bringing the negative electrode terminal plate 7 into close contact with the opening 1a of the battery case 1. Then, the outer surface of the battery case 1 was covered with an exterior label 8, thus completing an AA alkaline battery according to Example.

The gasket 5 was formed using nylon 6-12 with an injection-molding method. The gasket 5 was provided with a thinner portion 54 having a cross-sectional area (S) of 0.071 cm² and a thickness (d) of 0.24 mm. In consideration of data (the value of the coefficient k) on the preliminary example described above, this design provided a hydrogen gas permeability coefficient [k×(S/d)] of 3.1×10⁻¹⁰ (cm³H₂ (STP)/sec·cmHg) per one gasket of nylon 6-12 used in Example.

As the negative electrode current collector 6, a brass wire plated with Sn was used. As the separator 4, an alkaline battery separator (i.e., a composite fiber made of vinylon and tencelb) produced by KURARAY CO., LTD. was used.

### Comparative Example

In Comparative Example, nylon 6-6 was used as a material of a gasket formed by injection-molding. The other conditions were the same as the method for fabricating an AA alkaline battery of Example including the thickness and cross-sectional area of the thinner portion of the gasket. In this manner, an AA alkaline battery according to Comparative Example was fabricated.

In consideration of the results of the preliminary examination, it was calculated that the hydrogen gas permeability coefficient [k×(S/d)] per one nylon 6-6 gasket of Comparative Example was 0.99×10⁻¹⁰ (cm³H₂(STP)/sec·cmHg).

### (Battery Evaluation)

For batteries of each of Example and Comparative Example, 20 new batteries were left alone for 90 days at 60° C. in a humidified atmosphere of 90% RH to check whether leakage occurs or not.

As a result, the incidence of leakage was 0% for the batteries of Example, whereas the incidence of leakage was 15% for the batteries of Comparative Example. It is estimated that this is because of the mechanism described in the embodiment. Specifically, the gasket of Example has a hydrogen gas permeability coefficient per one gasket larger than that of the gasket of Comparative Example. Accordingly, it was concluded that hydrogen gas was released from the AA alkaline battery of Example upon generation of hydrogen gas without breakage of a gasket so that the leakage resistance was enhanced.

What is claimed is:

1. An AA alkaline battery, comprising:
a battery case having an opening; and
a gasket for sealing the opening,
wherein a positive electrode, a negative electrode, a separator provided between the positive electrode and the negative electrode, and an alkaline electrolyte are provided in the battery case,
the negative electrode contains 4.0 g or more of zinc, and
the gasket has a hydrogen gas permeability coefficient, per one gasket, in the range from 1.2×10⁻¹⁰ (cm³H₂(STP)/sec·cmHg) to 9.9×10⁻¹⁰ (cm³H₂(STP)/sec·cmHg), both inclusive.

2. The AA alkaline battery of claim 1, wherein the gasket has a thinner portion having a thickness, along the length of the battery case, smaller than the other portion of the gasket,
the thickness of the thinner portion is 0.25 mm or less, and
the thinner portion has a cross-sectional area of 0.04 cm² or more in the direction vertical to the thickness direction of the thinner portion.

3. The AA alkaline battery of claim 1, wherein the gasket is made of one of nylon 6-12 and a plastic containing nylon 6-12 as a main agent.

4. The AA alkaline battery of claim 1, wherein the negative electrode contains 400 ppm or less of indium with respect to the weight of zinc contained in the negative electrode.
